(19) United States
(12) Patent Application Publication
(10) Pub. No.: US 2020/0063419 A1
(43) Pub. Date: Feb. 27, 2020

(54) AN ELECTRONICALLY CONTROLLED FLUSHING SYSTEM AND METHOD OF OPERATION FOR THE SAME

(71) Applicant: ECZACIBASI YAPI GEREÇLERI SANAYIVE TICARET ANONIM SIRKETI, Istanbul (TR)

(72) Inventors: Bogaç SÌMSÌR, Istanbul (TR); Sefa HAZIR, Istanbul (TR)

(21) Appl. No.: 16/465,481

(22) PCT Filed: Dec. 14, 2017
(86) PCT No.: PCT/TR2017/050667

§ 371 Date: May 30, 2019

(30) Foreign Application Priority Data
Dec. 21, 2016 (TR) 2016/19159

(51) Int. Cl. E03D 5/10; G01M 3/32

(52) U.S. Cl. CPC E03D 5/10; G01M 3/3245

(57) ABSTRACT

A flushing system has a water reservoir; discharge equipment enabling delivery of water into the toilet bowl; the triggering member, which enables the water to be delivered via the discharge equipment; the normal operating mode in which the water is transferred by the triggering member; the standby mode in which the predetermined quantity of the water is transferred at the first predetermined period; the level measurement member enabling the level of water within the reservoir to be determined at a second period; the control panel comprising the first control member enabling the flushing system to operate in normal or standby mode; and the control unit for containing the information about the optimum water level within the reservoir, for comparing the level data to the optimum level information, for enabling the predetermined quantity of the water to be delivered at the first period when the flushing system is in standby mode.

### RELEVANT TECHNICAL FIELD

The present invention relates to the electronically controlled flushing systems and the methods of operation for the same.

### PRIOR ART

The cleanliness and hygiene of the toilet bowls are provided by means of the systems referred to as the flushing systems wherein said systems comprise at least one reservoir for the storage of the water obtained from a source (such as a municipal water distribution network) and the discharge equipment for the delivery of the water within the reservoir into the toilet bowl. The user, in case he/she needs, activates the discharge equipment via a triggering member and enables the water within said reservoir to be delivered into the toilet bowl.

However, as the flushing systems of the state of the art are the systems that are activated manually by a user, a portion of the water within the reservoir evaporates when said systems are not used for a certain duration of time (in other words, when the water within the reservoir stays within the reservoir for a certain duration of time without being delivered into the toilet bowl), and thus, no adequate water is left within the reservoir. In this case, the cleaning of the toilet bowl may not be performed effectively when the user engages the flushing system again, which in turn could lead to the problem of hygiene.

In addition, when said flushing systems are not used for quite a long time, the water present in the toilet drain also evaporates, and thus, the quantity of said water becomes reduced. This situation causes the development of malodor within the toilet room. Further, since the water within the toilet bowl remains still during said period of non-use, the growth of bacteria in the toilet bowl is accelerated, causing the toilet bowl to become both unhealthy and uncomfortable.

### BRIEF DESCRIPTION OF THE INVENTION

The electronically controlled flushing system developed according to the present invention is suitable for use in the delivery of water into a toilet bowl especially for cleaning said toilet bowl and comprises at least one reservoir where the water obtained from a source is stored; at least one discharge equipment enabling the delivery of the water within the reservoir into the toilet bowl; at least one triggering member, which is associated with the discharge equipment, is able to be actuated mechanically, in a touch-operated manner or in a non-contact manner, and enables, when actuated by a user, the water within the reservoir to be delivered into the toilet bowl via the discharge equipment; a normal operating mode in which the water within the reservoir is transferred into the toilet bowl by the use of said triggering member; a standby mode in which a predetermined quantity of the water that is present within the reservoir is transferred into the toilet bowl at a first predetermined period in case the toilet bowl will not be used for a certain duration of time; at least one level measurement member enabling the level of water within said reservoir to be determined at a second predetermined period; at least one control panel comprising at least one control member enabling the operation of the flushing system to be controlled by a user by means of an interface and enabling the flushing system to be set for operation in the normal operating mode or in the standby mode; and at least one control unit connected to said level measurement member and said control panel, for containing the information about the optimum water level desired to be present within the reservoir, for receiving the level data obtained from the level measurement member, for comparing said level data to said optimum level information, for enabling the predetermined quantity of the water that is present within the reservoir to be delivered into the toilet bowl at said first period in case the flushing system is in the standby mode.

The method of operation developed comprises the steps of determining the mode of the flushing system by means of said first control member; transferring, according to said first period, a quantity of water that is kept recorded in the control unit into the toilet bowl without using the triggering member when the standby mode is selected; performing the transfer of water from the reservoir into the toilet bowl manually by means of said triggering member when the normal operating mode is selected; and refilling, after the transfer of water into the toilet bowl in the normal operating mode, the reservoir with that quantity of water that has been transferred into the toilet bowl.

Owing to the flushing system and method of operation developed according to the present invention, it is possible to prevent the malodor development and bacterial growth in a simple and practical manner in cases where the toilet bowl will not be used for quite a long time. In this way, the highest level of ability may be provided in terms of meeting the hygiene requirement for the toilet rooms.

### OBJECT OF THE INVENTION

An object of the present invention is to devise a flushing system, which is controlled in an automated and/or digitalized manner, and a method of operation for said flushing system. Another object of the present invention is to devise an electronically controlled flushing system, which reduces the bacterial growth in the toilet bowl, and a method of operation for said flushing system.

Another object of the present invention is to devise an electronically controlled flushing system, which reduces the development of malodor in the toilet bowl, and a method of operation for said flushing system.

Another object of the present invention is to devise an electronically controlled flushing system, which enables the toilet bowl to be cleaned in an effective manner and thus enables a high level of hygiene to be achieved, and a method of operation for said flushing system.

### DESCRIPTION OF THE FIGURES

The representative embodiments of the flushing system developed according to the present invention are shown in the accompanying figure in which:

FIG. 1 is a perspective view of the flushing system developed.

FIG. 2 is an exemplary illustration of a control panel that the developed flushing system comprises.

The parts in the figures are individually assigned with reference numerals and the designations for the reference numerals are provided below:
Flushing system (F)
Reservoir (H)
Control panel (K)
First control member (K1)
Second control member (K2)

### DESCRIPTION OF THE INVENTION

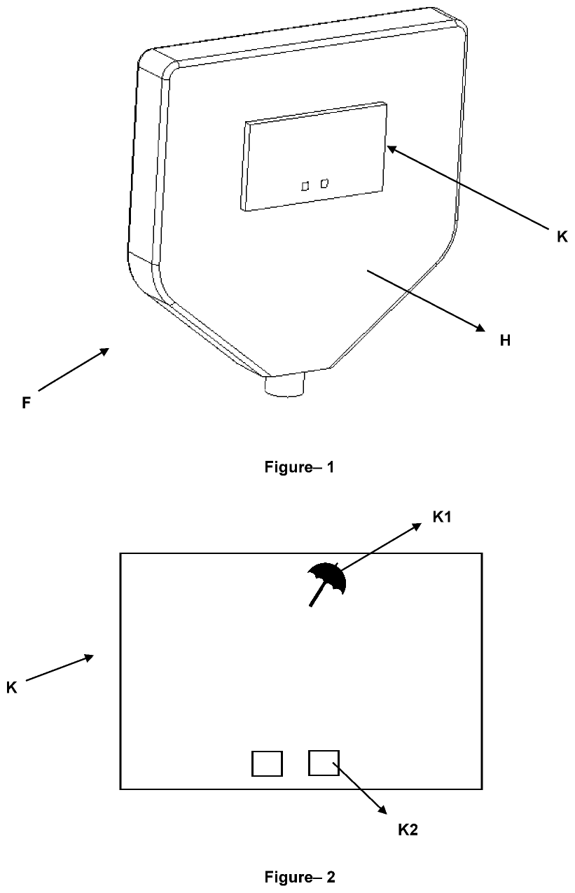

The cleaning of the toilet bowls following the use thereof is carried out via various flushing systems comprising at least one reservoir for the storage of the water to be used in cleaning, at least one discharge equipment providing the delivery of water within the reservoir into the toilet bowl and at least one triggering member enabling the discharge equipment to be activated manually. In such flushing systems, the delivery of water within the reservoir into the toilet bowl is controlled manually by a user, in which case the water in the toilet drain evaporates and leads to the development of malodor when the water within the reservoir is not delivered into the toilet bowl for quite a long duration of time (for example when a user goes on a holiday). Moreover, the water in the toilet bowl remains still since the water within the reservoir is not delivered into the toilet bowl for a quite a long duration of time, which in turn accelerates the bacterial growth within the water in the toilet bowl. For this reason, an electronically controlled flushing system and a method of operation for said flushing system are developed according to the present invention in order to avoid the problems related to the comfort and hygiene likely to arise in a toilet bowl when not in use for quite a long time. The electronically controlled flushing system (F) developed according to the present invention, exemplary views of which are provided in FIG. 1 and FIG. 2, is suitable for use in the delivery of water into a toilet bowl especially for cleaning said toilet bowl and comprises at least one reservoir (H) where the water obtained from a source (such as a municipal water distribution network or an external storage tank) is stored; at least one discharge equipment enabling the delivery of the water within the reservoir (H) into the toilet bowl; and at least one triggering member, which is associated with the discharge equipment, is able to be actuated mechanically, in a touch-operated manner or in a non-contact manner, and enables, when actuated by a user, the water within the reservoir (H) to be delivered into the toilet bowl via the discharge equipment. The developed flushing system (F) further comprises a normal operating mode in which the water within the reservoir (H) is transferred into the toilet bowl by the use of said triggering member; a standby mode in which a predetermined quantity of the water that is present within the reservoir (H) (for example the entire quantity of the water within the reservoir or 500 ml of the same) is transferred into the toilet bowl at a first predetermined period (said first period being preferably a period able to be set by the user according to the duration for which the toilet bowl will not be in use) in case the toilet bowl will not be used for a certain duration of time; at least one level measurement member enabling the level of water within said reservoir (H) to be determined at a second predetermined period (preferably in an instantaneous manner); at least one control panel (K) comprising at least one first control member (K1) enabling the operation of the flushing system (F) to be controlled by a user by means of an interface and enabling the flushing system (F) to be set for operation in the normal operating mode or in the standby mode; and at least one control unit connected to said level measurement member and said control panel (K), for containing the information about the optimum water level desired to be present within the reservoir (H), for receiving the level data obtained from the level measurement member, for comparing said level data to said optimum level information, for enabling the predetermined quantity of the water that is present within the reservoir (H) to be delivered into the toilet bowl at said first period in case the flushing system (F) is in the standby mode, and for enabling, preferably after the predetermined quantity of water has been delivered into the toilet bowl, the intake of water from the source to the reservoir (H) such that the water level within the reservoir (H) corresponds to said optimum level based on the level data received from the level measurement member. Said first control member (K1) is preferably a member that may be triggered mechanically, in a touch-operated manner or in a non-contact manner (e.g. a button, switch, sensor, etc.). In addition, the predetermined quantity of water to be transferred into the toilet bowl in the standby mode is preferably a quantity able to be set by the user.

The method of operation developed according to the present invention comprises the steps of determining the mode of the flushing system (F) by means of said first control member (K1); transferring, according to said first period, a quantity of water that is kept recorded in the control unit into the toilet bowl without using the triggering member when the standby mode is selected; performing the transfer of water from the reservoir (H) into the toilet bowl manually by means of said triggering member when the normal operating mode is selected; and refilling, after the transfer of water into the toilet bowl, the reservoir (H) with that quantity of water that has been transferred into the toilet bowl. Preferably according to the developed method, said first period information and/or the information about the quantity of water to be transferred into the toilet bowl when the standby mode is selected is/are determined by the user and saved in the control unit by means of the control panel (K). Also preferably according to said method of operation, when in the standby mode, said level measurement member measures the water level within the reservoir (H) according to the second period and compares such level to the optimum water level. Once the transfer of water into the toilet bowl has been performed, the quantity of water that has been transferred into the toilet bowl, which is determined as a result of such comparison, is introduced to the reservoir (H) again.

According to a representative embodiment of the present invention, the user determines the mode of the flushing system (F) by means of the first control member (K1). When the user selects the normal operating mode, the flushing system (F) operates in such a way that the discharge equipment is controlled manually by means of the triggering member. On the other hand, when the user selects the standby mode, a portion (or entirety) of the water that is present within the reservoir (H) is transferred into the toilet bowl at a first period (for example once every 24 hours), and then, the intake of water to the reservoir (H) is preferably carried out again so that the quantity of water within the reservoir (H) reaches said optimum level. This period continues in a cyclical manner until the flushing system (F) is set back to the normal operating mode.

According to a preferred embodiment of the invention, the flushing system (F) developed comprises at least one second control member (K2) wherein said second control member (K2) controls the access to said interface and the active/passive state of the first control member (K1). In other words, for example when the user wishes to change the mode of the flushing system (F) by means of the first control member (K1), he/she first triggers the second control member (K2), after which the first control member (K1) becomes activated to allow the mode selection. In this way, the mode of the flushing system (F) may be prevented from being changed inadvertently and a reliable system may be obtained. Said second control member (K2) is preferably a member that may be triggered mechanically, in a touch-operated manner or in a non-contact manner (e.g. a button, switch, sensor, etc.).

According to another alternative embodiment of the invention, the flushing system (F) developed comprises at least one indicator positioned on the control panel (K) for informing the user about the operating mode of the flushing system (F).

According to another preferred embodiment of the invention, the method of operation developed comprises the steps of continuously determining, at said second predetermined period, the water level within the reservoir (H) by means of said level measurement member in the normal operating mode and/or the standby mode; comparing the determined water level to said optimum water level; determining the level difference in case the determined water level is below the optimum water level and introducing the water in a quantity that corresponds to such determined level difference from said source to the reservoir (H) to thereby bring the water level within the reservoir (H) into the optimum level. According to this embodiment, the developed method preferably further comprises the step of determining the quantity by which the water within the reservoir (H) has reduced, based on the determined level difference and by the use of the information about the dimensions of the reservoir (H). In this way, the reduction in the quantity of water within the reservoir (H) resulting from the evaporation may be determined and the transfer of water into the toilet bowl may be enabled to be performed each time with an adequate quantity. According to this embodiment, said second period information may be preferably determined by the user and may be saved in the control unit via said control panel (K).

The method of operation developed further comprises the step of warning the user by means of a warning member in case there is not water available within the reservoir (H) when the standby mode is selected and/or in case the transfer of water into the toilet bowl has been performed by the use of said triggering member when the standby mode is selected and/or in case the water within the reservoir (H) has not been able to be transferred into the toilet bowl when the standby mode is selected.

According to another alternative embodiment of the present invention, the method of operation developed further comprises the steps of discharging, in the standby mode, all of the water within the reservoir (H) and keeping the reservoir (H) empty without refilling the water into the same throughout said first period until the subsequent discharge action; filling the reservoir (H) with water up to said optimum level at the end of said first period and transferring said water back into the toilet bowl to bring the reservoir (H) back into the empty state. In this way, in cases where the toilet bowl will not be used for quite a long time, the moss development likely to occur within the reservoir (H) may also be prevented and a more hygienic flushing system (F) may be obtained. According to this embodiment, the method of operation further comprises the step of warning the user by means of a warning member in case the water within the reservoir (H) has not been able to be transferred into the toilet bowl when the flushing system (F) is switched into the standby mode.

Owing to the flushing system (F) and method of operation developed according to the present invention, it is possible to prevent the malodor development and bacterial growth in a simple and practical manner in cases where the toilet bowl will not be used for quite a long time. In this way, the highest level of ability may be provided in terms of meeting the hygiene requirement for the toilet rooms.

1. A flushing system suitable for use in the delivery of water into a toilet bowl especially for cleaning said toilet bowl, comprising
at least one reservoir where the water obtained from a source is stored;
at least one discharge equipment enabling the delivery of the water within the reservoir into the toilet bowl; and
at least one triggering member, which is associated with the discharge equipment, is able to be actuated mechanically, in a touch-operated manner or in a non-contact manner, and enables, when actuated by a user, the water within the reservoir to be delivered into the toilet bowl via the discharge equipment;
characterized in that it comprises
a normal operating mode in which the water within the reservoir is transferred into the toilet bowl by the use of said triggering member;
a standby mode in which a predetermined quantity of the water that is present within the reservoir is transferred into the toilet bowl at a first predetermined period in case the toilet bowl will not be used for a certain duration of time;
at least one level measurement member enabling the level of water within said reservoir to be determined at a second predetermined period;
at least one control panel comprising at least one first control member enabling the operation of the flushing system to be controlled by a user by means of an interface and enabling the flushing system to be set for operation in the normal operating mode or in the standby mode; and
at least one control unit connected to said level measurement member and said control panel, for containing the information about the optimum water level desired to be present within the reservoir, for receiving the level data obtained from the level measurement member, for comparing said level data to said optimum level information, for enabling the predetermined quantity of the water that is present within the reservoir to be delivered into the toilet bowl at said first period in case the flushing system is in the standby mode.

2. A flushing system according to claim 1 characterized in that said first period is a period that is able to be set by the user according to the duration of time for which the toilet bowl will not be used.

3. A flushing system according to claim 1 characterized in that the predetermined quantity of water to be transferred into the toilet bowl in the standby mode is a quantity that is able to be set by the user.

4. A flushing system according to claim 1 characterized in that said control unit is a unit, which enables, after the predetermined quantity of water has been delivered into the toilet bowl in the standby mode, the intake of water from the source to the reservoir such that the water level within the reservoir corresponds to said optimum level based on the level data received from the level measurement member.

5. A flushing system according to claim 1 characterized in that said first control member is a member that may be triggered mechanically, in a touch-operated manner or in a non-contact manner.

6. A flushing system according to claim 1 characterized in that it comprises at least one second control member, which controls the access to said interface and the active/passive state of the first control member.

7. A flushing system according to claim 6 characterized in that said second control member is a member that may be triggered mechanically, in a touch-operated manner or in a non-contact manner.

8. A flushing system according to claim 1 characterized in that it comprises at least one indicator positioned on the control panel for informing the user about the operating mode of the flushing system.

9. A method of operation suitable for use in a flushing system according to claim 1, characterized in that it comprises the steps of:
determining the mode of the flushing system by means of said first control member;
transferring, according to said first period, a quantity of water that is kept recorded in the control unit into the toilet bowl without using the triggering member when the standby mode is selected;
performing the transfer of water from the reservoir into the toilet bowl manually by means of said triggering member when the normal operating mode is selected; and
refilling, after the transfer of water into the toilet bowl in the normal operating mode, the reservoir with that quantity of water that has been transferred into the toilet bowl.

10. A method of operation according to claim 9 characterized in that it comprises the steps of the user determining said first period information when the standby mode is selected and saving said information in the control unit by means of the control panel.

11. A method of operation according to claim 9 characterized in that it comprises the steps of the user determining the information about the quantity of water to be transferred into the toilet bowl when the standby mode is selected and saving said information in the control unit by means of the control panel.

12. A method of operation according to claim 9 characterized in that it comprises the steps of measuring, when in the standby mode, the water level within the reservoir according to said second period by means of said level measurement member and comparing such level to the optimum water level; introducing, once the transfer of water into the toilet bowl has been performed, the quantity of water that has been transferred into the toilet bowl, which is determined as a result of such comparison, to the reservoir again.

13. A method of operation according to claim 9 characterized in that it comprises the steps of continuously determining, at said second predetermined period, the water level within the reservoir by means of said level measurement member in the normal operating mode and/or the standby mode; comparing the determined water level to said optimum water level; determining the level difference in case the determined water level is below the optimum water level and introducing the water in a quantity that corresponds to such determined level difference from said source to the reservoir to thereby bring the water level within the reservoir into the optimum level.

14. A method of operation according to claim 13 characterized in that it comprises the step of determining the quantity, by which the water within the reservoir has reduced, based on the determined level difference and by the use of the information about the dimensions of the reservoir.

15. A method of operation according to claim 13 characterized in that it comprises the steps of the user determining said second period information and saving said information in the control unit by means of the control panel.

16. A method of operation according to claim 9 characterized in that it comprises the step of warning the user by means of a warning member in case there is not water available within the reservoir when the standby mode is selected and/or in case the transfer of water into the toilet bowl has been performed by the use of said triggering member when the standby mode is selected and/or in case the water within the reservoir has not been able to be transferred into the toilet bowl when the standby mode is selected.

17. A method of operation according to claim 9 characterized in that it comprises the steps of discharging, in the standby mode, all of the water within the reservoir and keeping the reservoir empty without refilling the water into the same throughout said first period until the subsequent discharge action; filling the reservoir with water up to said optimum level at the end of said first period and transferring said water back into the toilet bowl to bring the reservoir back into the empty state.

18. A method of operation according to claim 17 characterized in that it comprises the step of warning the user by means of a warning member in case the water within the reservoir has not been able to be transferred into the toilet bowl when the flushing system is switched into the standby mode.
